(19) United States
(12) Patent Application Publication
(10) Pub. No.: US 2025/0007784 A1
(43) Pub. Date: Jan. 2, 2025

(54) Advisor Service for Network Aware Collective Communication Patterns

(71) Applicant: International Business Machines Corporation, Armonk, NY (US)

(72) Inventors: Joshua James Hursey, La Crosse, WI (US); Austen William Lauria, Fishkill, NY (US); William P. LePera, Wappingers Falls, NY (US); Scott Miller, Meadville, PA (US); Robert Perricone, Poughkeepsie, NY (US)

(21) Appl. No.: 18/214,602

(22) Filed: Jun. 27, 2023

(51) Int. Cl. H04L 41/122; H04L 67/10

(52) U.S. Cl. CPC H04L 41/122; H04L 67/10

(57) ABSTRACT

Mechanisms are provided for optimization of a collective communication operation. A network graph data structure for a network of computing devices is generated that includes nodes representing computing devices of the network and edges comprising communication links between the computing devices. Each edge of the network graph data structure is weighted based on a multi-dimensional weight comprising network performance characteristics collected from the network. For a specified collective communication operation, and for participant devices of the network that are participating in the specified collective communication operation, a collective communication pattern is determined based on the multi-dimensional weights of the network graph data structure and a type of the collective communication operation. The determined collective communication pattern is returned to one or more of the participant devices which perform the collective communication operation based on the collective communication pattern.

### BACKGROUND

The present application relates generally to an improved data processing apparatus and method and more specifically to an improved computing tool and improved computing tool operations/functionality for network aware collective communication patterns.

Collective communication operations are often used in distributed computing systems. For example, collective communication operations may be used to broadcast a message to a set of participants (e.g., processes, computing devices, machines, etc.) across one or more data networks. Broadcasting a message involves an origin participant (sometimes referred to as the “root”) sending the same message to a set of remote participants. Scattering a message may be seen as a derivation of the broadcast operation where the origin participant sends a different message to each remote participant. Other types of collective communication operations may include barrier synchronization, gather and all gather, reduction, and the like. For example, a global gather operation may involve everyone sending data to their “right neighbor” and receiving data from their “left neighbor” in a series of rounds until everyone has the required data. A similar technique may be used in a global reduction where all processes perform an accumulate operation or max operation on the data distributed between the processes to arrive at a consistent single value at all processes.

The efficiency of collective communication operations is a centerpiece of many parallel and distributed applications and system services in modern distributed computing systems, such as data centers, especially as they scale-out. Many High-Performance Computing (HPC) and many Machine Learning (ML) applications rely on the Message Passing Interface (MPI) standard and similar libraries for point-to-point and collective communication between distributed operations. The MPI standard defines the MPI_Bcast and MPI_Scatter (v) operations for these two widely used collectives. Additionally, other collective algorithms, such as MPI_Allgather and MPI_Allreduce, often rely on broadcast and scatter operations to support higher level algorithms.

Broadcast and scatter collective algorithms are also beneficial to distributed systems of persistent daemons for the distribution of information. For example, HPC schedulers and job launchers frequently use collective communication patterns to update the distributed state and send “job launch” messages to all remote computing systems, which starts the distributed application. Specifically, the latter examples of job launch greatly benefits from efficient broadcast and scatter algorithms yielding faster launch times for user applications and increasing machine utilization. Improvements to collective communication patterns, especially in dynamic networking environments such as the cloud, can yield significant performance benefits for client applications and data center middleware.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for optimization of a collective communication operation. The method comprises generating a network graph data structure for a network of computing devices. The network graph data structure comprises nodes representing computing devices of the network and edges comprising communication links between the computing devices. The method further comprises weighting each edge of the network graph data structure based on a multi-dimensional weight comprising network performance characteristics collected from the network. In addition, the method comprises determining, for a specified collective communication operation and for participant devices of the network that are participating in the specified collective communication operation, a collective communication pattern based on the multi-dimensional weights of the network graph data structure and a type of the collective communication operation. Moreover, the method comprises returning the determined collective communication pattern to one or more of the participant devices which perform the collective communication operation based on the collective communication pattern.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example diagram of a collective communication pattern advisor (CCPA) service engine in accordance with one or more illustrative embodiments;

FIG. 3 is a block diagram of an example collective communication pattern, shown as a tree structure, which may be generated by the CCPA service engine in accordance with one or more illustrative embodiments;

FIG. 4 is a block diagram of an example broadcast operation that may be performed using the collective communication pattern of FIG. 3 in accordance with one illustrative embodiment;

FIG. 5 is a block diagram of an example scatter operation that may be performed using the collective communication pattern of FIG. 3 in accordance with one illustrative embodiment;

FIG. 6 is a block diagram of an example combination broadcast/scatter operation that may be performed using the collective communication pattern of FIG. 3 in accordance with one illustrative embodiment;

FIG. 7 is a flowchart outlining an example operation for generating a collective communication pattern recommendation in accordance with one illustrative embodiment;

FIG. 8 is a flowchart outlining an example operation for providing a collective communication pattern recommendation in response to a token based request or query in accordance with one illustrative embodiment;

FIG. 9 is a flowchart outlining an example operation for initiating a collective communication operation in accordance with one or more illustrative embodiments; and

FIG. 10 is a flowchart outlining an example operation for performing a collective communication operation from the view of a child node in accordance with one or more illustrative embodiments.

### DETAILED DESCRIPTION

The illustrative embodiments provide an improved computing tool and improved computing tool operations/functionality that provides an advisor computing service for recommending network aware collective communication patterns. The illustrative embodiments operate to automatically identify an efficient collective communication pattern for collective communications, e.g., broadcast or scatter, taking into account the state of the data network along multiple dimensions as well as requirements of the collective communication process. The mechanisms of the illustrative embodiments generate the collective communication pattern recommendations which may then be used to automatically perform collective communication by one or more origin/source, or sending, computing systems, i.e., computing system(s) that are senders of data, and the other participants, e.g., processes, computing systems/devices, machines, etc., involved in the distributed, or collective communication, algorithms of a computing device group.

As mentioned above, the broadcast and scatter algorithms have become increasingly used by HPC and ML processes. Because of their increased usage, broadcast and scatter algorithms are used as examples herein, but the illustrative embodiments are not limited to only these types of collective communications and instead are applicable to any collective communication between computing resources/processes. Existing broadcast and scatter algorithms require that members know the collective communication pattern (e.g., tree structure) before the operation begins to understand their role in the communication protocol. However, the collective communication pattern needs to be able to adapt, such as to changes in collective computing device group membership, changing network conditions, and/or changes in message size. The collective communication pattern should be able to be dynamically updated and distributed before starting the collective operation, where the “collective operation” is the operation that the participants are involved in, and the collective communication is the communication of data between the participants to achieve the performance of this collective operation.

The efficiency of the collective communication between computing devices of a collective computing device group is determined by the pattern of sending and receiving messages within that collective computing device group. This collective communication may be represented by a tree-structured communication pattern, or a communication pattern structured in a series of stages that is determined and used to perform the collective communication for the collective operation. For example, if a process executing within a collective computing device group, e.g., on one or more of the computing devices, such as the origin or root computing device, wishes to send data to the computing devices of the collective computing device group (hereafter referred to simply as the “collective group”), such as in a broadcast or scatter operation, the collective communication pattern may be used to identify which pathways to use to provide the most efficient routing of data to the computing devices. This collective communication pattern should account for the changing conditions, e.g., network latency, network bandwidth, network congestion, network usage, network process affinity, etc., as well as any number of other network conditions, to construct the best possible pattern for a given collective operation since network conditions can adversely impact the performance of the collective operation.

The illustrative embodiments provide an improved computing tool and improved computing tool operations/functionality that implements a collective communication pattern advisor service which combines knowledge of the state of the data network, a multidimensional network edge weighting technique, and knowledge of collective algorithm requirements to create network-aware, collective communication pattern recommendations for a collective group of participants, e.g., processes, computing systems/devices, machines, etc., involved in a collective operation, such as in the case of a distributed parallel application.

The illustrative embodiments provide an improved computing tool and improved computing tool operations/functionality that applies a mapping algorithm best suited for the particular collective operation based on this multidimensional weighted network graph data structure and the collective communication requirements. For example, in some illustrative embodiments, for any requested collective communication operation, the collective communication pattern advisor of the illustrative embodiments applies a plurality of mapping algorithms to the current network subgraph, i.e., the subset of the network graph containing just the collective communication participants, from the multidimensional weighted network graph data structure. Each mapping algorithm generates a candidate communication pattern. All of the candidate communication patterns for the collective operation are evaluated to select the best candidate communication pattern among the set of candidate communication patterns. This evaluation uses a theoretical model with the multidimensional weighted network graph to arrive at a cost score for the candidate collective communication pattern. The collective communication pattern with the lowest overall cost may then be selected as a collective communication pattern recommendation.

Before discussing the illustrative embodiments in greater detail, it should be appreciated that the following description utilizes the following terminology in the description of the illustrative embodiments:
Server: A machine in the cluster containing one or more computational units (e.g., central processing unit (CPU), graphics processing unit (GPU), field programmable gate array (FPGA), or the like) and connected to the network with one or more network interfaces (e.g., network interface cards (NICs)).
Cluster: A networked set of computing devices, e.g., servers, viewed as a single system.
Process: A running instance of a computer program that may contain one or more threads of execution.
Parallel Application: A computer application with more than one process communicating with other processes on the same computing device, e.g., server, and on different computing devices, e.g., servers, in the cluster to perform a single logical task.
Point-to-Point Communication: When two processes in a parallel application send or receive data between themselves.
Collective Communication: When a group of processes in a parallel application perform a coordinated communication action on a set of data at logically the same time. For example, broadcasting data to all processes (e.g., MPI_Bcast), gathering data from all processes (e.g., MPI_Gather, MPI_Allgather), sharing segments of data between all processes (e.g., MPI_Scatter, MPI_Alltoall), and performing mathematical operations on a set of distributed data (e.g., MPI_Reduce, MPI_Allreduce).

With this terminology in mind, the collective communication pattern advisor (CCPA) service of the illustrative embodiments is provided information about a collective operation, including the type of collective group (e.g., broadcast, scatter, reduce, global gather, etc.), origin computing system/device/process, or the “root”, of the collective operation (if applicable), and optionally an estimation of the message sizes involved in the collective operation. This information may be provided by a parallel application that is being executed and wishes to perform the collective operation, for example. These factors are then factored into the CCPA service's collective communication pattern generation.

For example, the type of collective operation (e.g., broadcast, reduce, global gather) has associated with it a set of mapping algorithms that are designed to take a network subgraph and map the collective communication operation (sometimes also referred to herein as the “collective operation”) to the network subgraph. The mapping algorithm will use the other information (e.g., root, message size, etc.) to inform its construction of the collective communication pattern in connection with the network subgraph and associated multidimensional edge weights. Each edge in the network subgraph has associated with it a tuple of values (e.g., congestion, historical data, latency, etc.) and a static, final weight that the mapping algorithm uses when calculating the collective communication pattern.

The collective communication pattern is then returned to the client, e.g., the parallel application, which called the CCPA service, such as via an Application Programming Interface (API) call or the like. In some illustrative embodiments, in this context, the parallel application comprises a plurality of processes that work together to perform a collective communication operation. Any subset of those processes may query the CCPA service for the collective communication pattern. A single process that queries the CCPA service is a “client” of the CCPA service.

In one example, for a rooted collective communication operation (e.g., broadcast) the root of the operation will be designated as the corresponding client. The root will then query the CCPA service and receive the collective communication pattern. The root will then choose how to share that collective communication pattern with the rest of the participants.

In another example, in a non-rooted collective operation (e.g., global gather), the parallel application may designate a single process to be the corresponding client to the CCPA service. That client process will query the CCPA service for the collective communication pattern. That client process may distribute the “token” associated with the collective communication pattern, as discussed hereafter, which is returned by the CCPA service to all other processes in the parallel application. At that point all of the other processes in the parallel application may query the CCPA service for their copy of the collective communication pattern associated with that token, using the token distributed to them by the client process. For this token based query, each of the processes becomes a client to the CCPA server. Here a client is any process external to the CCPA service that is in communication with the CCPA service.

The CCPA service operates to generate the collective communication pattern at least by combining knowledge of the state of the network, a multidimensional network edge weighting technique, and knowledge of collective operation algorithm requirements to create specific collective communication pattern recommendations for a group of participants, e.g., processes, involved in the execution of a parallel application, such as a members of the collective group. The parallel application accesses the generated collective communication pattern via an Application Programming Interface (API) provided by the CCPA service. The CCPA service maintains at least one general graph data structure representing a graph of the network-connected components in the cluster, where the cluster is a networked set of computing devices. Each server contains computational and network components with the general graph of the cluster being a graph of these computational and network components of the computing devices, e.g., servers.

As noted above, a parallel application consists of a plurality of processes working together. Each process is running on a computing device, e.g., server (used hereafter as a non-limiting example of a computing device), in the cluster. Each process can use all or a subset of the components of the server, e.g., it may be restricted to use a subset of the network devices on a single server. A collective group is the set of processes participating in the collective operation, but does not need to be the full set of processes in the parallel application.

Thus, the cluster and servers are physical components of the system represented in the general graph. The parallel application and processes within it are running on the servers in the cluster connected via network connected components on those servers (vertices in the graph). The set of processes in the parallel application involved in the collective operation are the participants in the collective operation.

In illustrative embodiments with a network monitoring service, e.g., IBM Tivoli Network Manager, the network monitoring service can be used to provide this graph of the network-connected components in the cluster to the CCPA service, which may be a separate entity from the network monitoring service. Alternatively, in some illustrative embodiments, the CCPA service may be integrated into the network monitoring service and obtain the graph data structure accordingly. In some illustrative embodiments, where a network monitoring service is not available, the CCPA service can use standard network discovery and monitoring tools to establish and maintain the graph data structure.

In any of these illustrative embodiments, the graph data structure comprises a graph having vertices that represent processing nodes, e.g., computing systems/devices, and network interface pairs, e.g., server-and-network-interface pairs, because processes only execute on processing nodes and the processes are the only messaging actors in the parallel application. Processes communicate with each other via either shared memory within a processing node, or through a specific set of network interfaces connected to the processing node on which the processes are executing. The edges in the graph data structure represent physical (e.g., networking cable) and/or logical (e.g., dedicated route for QoS) network connections between the vertices.

In accordance with the illustrative embodiments, the CCPA service annotates the edges in the graph data structure with a multidimensional weight. The weighting of edges in the graph data structure plays a significant role in the efficiency of the algorithm, or algorithms, that seek to map an efficient collective communication pattern to the graph data structure. Different collective communication operations require various aspects of the edges to be prioritized over others. For example, a small message broadcast operation is latency-bound and benefits from consistent small message performance. Alternatively, a large message scatter operation is bandwidth-bound and benefits from edges in the collective communication pattern that do not overlap and have reduced contention on network resources. Maintaining a multidimensional weight on each edge allows the pattern creation algorithm, or set of collective communication pattern mapping algorithms, of the CCPA service to define the weight on that edge based on the collective operation that it, or they, are trying to optimize. The CCPA service may choose to consume network events, e.g., from a network monitoring service, to maintain these multidimensional edge weights over the life of the CCPA service.

The edges in the graph data structure are weighted based on several characteristics. Since several factors may be essential to a given collective operation, a weighting factor is associated with each characteristic to adjust its importance in the final weight of the edge during the collective communication pattern generation algorithm computation. In accordance with some illustrative embodiments, the list presented below represents a sample ordered list of the most to least important factors, although in other illustrative embodiments, the factors may differ and the relative importance of the factors may differ from that represented below, without departing from the spirit and scope of the present invention. In some illustrative embodiments, each factor has a static multiplier representing relative overall importance to the collective communication pattern algorithm. The list of factors includes, but is not limited to:
Latency: The amount of time it takes for a packet of data to be captured, transmitted, processed along an edge, then received at its destination and decoded. As latency increases, its multiplier will also increase.
Bandwidth: The maximum amount of data that can be transferred at any given time along an edge. As available bandwidth increases, its multiplier will decrease.
Congestion: Measured as the number of retries and dropped packets along an edge. As congestion increases, its multiplier will increase.
Usage: Measured in relation to the number of other, previously established collective communication patterns that include this edge. As the number of patterns using an edge increases, the multiplier increases.
Process Affinity: The proximity of the computation unit (e.g., CPU, GPU, etc.) where a process is executing, to the network adapter card. This may be measured in relative distance or “hops.” As the distance increases, the Process Affinity multiplier will increase as it has been shown that awareness of process affinity can significantly improve messaging performance.
Historical Data: Patterns typically seen on the network, such as, but not limited to, traffic data and general usage. Historical data of the network is stored with the edge. The appropriate historical data is queried when calculating the resulting collective communication pattern. For example, if historical data shows an edge has been saturated at the same time every day, and a parallel application using that edge is scheduled to run during those times, the CCPA service can preemptively avoid that edge when calculating the collective communication pattern. A Recurrent Neural Network (RNN) may be used to maintain this type of information and generate classifications/predictions of such patterns for use by the CCPA service.
   As noted above, these are only examples of the factors that may be considered in the multidimensional weighting performed by the CCPA service with regard to the edges of the graph data structure when generating the collective communication pattern recommendations. Other factors, multipliers or weights, and relative importance of the factors may be utilized depending on the desired implementation of the improved computing tool and improved computing tool operations/functionality of the illustrative embodiments.

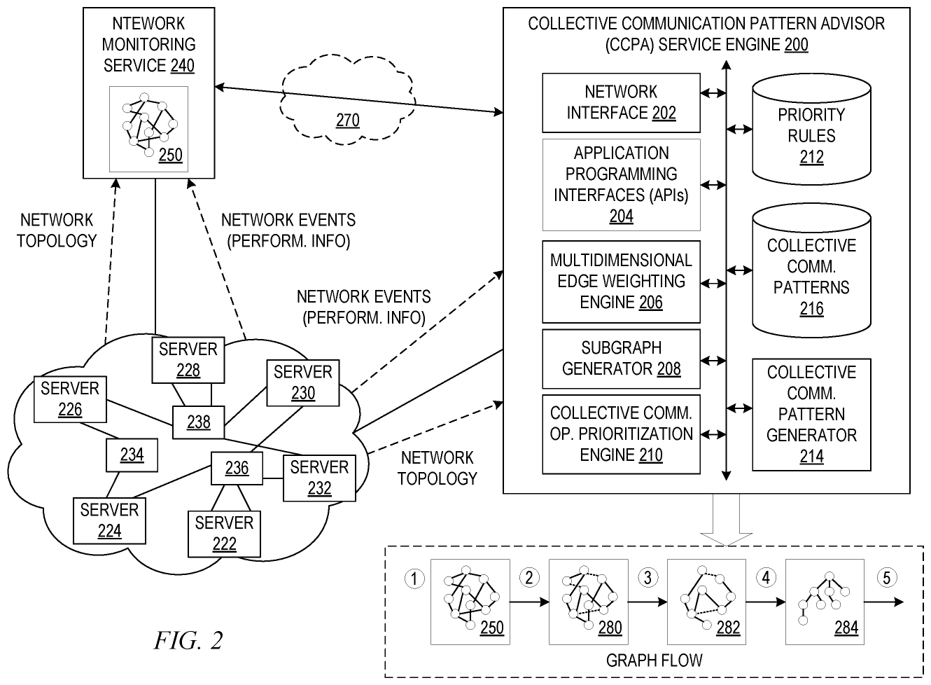

In some illustrative embodiments, the CCPA service contains a set of algorithms that take as input, from the client interacting with the CCPA service's API, information about the collective communication, which may include, for example, information specifying characteristics of the collective operation, root process (if any) of the collective operation, and a group of processes in the parallel application. That is, for example, the client, i.e., the computing device requesting the CCPA service via an API call to the API 204 in FIG. 2, for example, sends a request to the CCPA service engine that includes a collective communication operation to be performed, e.g., broadcast, scatter, reduce operation of accumulate to a root, etc., a specification of the root of the operation, if any, a set of participants (e.g., processes in the parallel application) involved in the collective operation, and other optional information such as message sizes and the like.

The CCPA service may make use of this optional information, such as expected message size, to enhance the CCPA service's recommended collective communication pattern further. For example, as noted earlier, small message broadcast and large message scatter operations may generate different collective communication patterns to better use the network. For example, when working on a broadcast collective operation of small data, the mapping algorithm(s) may choose edges in the multidimensional weighted graph data structure with the least latency between any two participating processes. Conversely, for a large message broadcast, the mapping algorithm(s) may take into account network bandwidth and congestion by reducing the use of congested links and prioritizing higher bandwidth links even if doing so would choose links with higher latency (since it is not as sensitive to the latency metric).

The CCPA service algorithms define a spanning subgraph of the broader cluster graph data structure, that only includes the specified set of processes, since they are the only messaging actors in the collective operation. The CCPA service algorithms produce a collective communication pattern based on the current network conditions combined with the input provided regarding the collective communication. There may be multiple different mapping algorithms implemented by the CCPA service to map a collective operation to a network graph data structure to produce a plurality of candidate collective communication patterns. The CCPA service may implement one or more of these mapping algorithms, based on the information received from the client and the current network conditions, and then selects a “best” collective communication pattern based on a scoring of these candidates, where the scoring is obtained from a theoretical model combined with current network performance metrics.

For example, the CCPA service algorithms that generate the collective communication pattern by mapping the collective operation to the general graph, may first take the spanning subgraph of the broader cluster graph data structure, and find the combination of edges in the spanning subgraph that have the least accumulated weight, but which connect all of the messaging actors. That is, the collective communication pattern comprises the nodes of the general graph data structure of the cluster, which are the message passing actors for the particular collective operation, and the edges between these nodes that have the least weight. The requirements of the particular collective operation may also be taken into consideration when selecting the edges between the nodes, such as mentioned above, to thereby prioritize different edges based on their particular weighting characteristics, e.g., latency is more heavily weighted that other factors if the collective communication is a small message broadcast operation, whereas large message scatter operations have the bandwidth more heavily weighted than other factors.

The CCPA service may maintain a set of prioritization rules that specify which factors to weight more heavily or less heavily for corresponding collective communication operations. These prioritization rules may be defined by an administrator of the cluster, or other authorized personnel, and may be updated as needed. Thus, there may be one or more prioritization rules for each type of collective communication operation, e.g., broadcast, scatter, gather, data sharing, and distributed mathematical operations, etc.

The CCPA service may inform network devices in the cluster of the collective communication pattern to improve the quality of service within the cluster once the CCPA service algorithms have established a collective communication pattern. For example, the CCPA service may broadcast or otherwise transmit to each of the switches, routers, and other computing devices of the spanning subgraph, the collective communication pattern or the token associated with the collective communication pattern such that the token may be used by each device to retrieve the collective communication pattern, as discussed hereafter. These network devices may then utilize this collective communication pattern when performing the switching and routing of data communications within the network so as to utilize the pathways specified when routing data packets from and to the various message passing actors of the collective operation. This may be done when updates to the collective communication pattern are generated as well, so that the switches, routers, and other computing devices are informed of changes to the collective communication patterns.

In this way, network offloading of the collective communication pattern generation may be realized. That is, network offload operations are operations in which the calling process tells the network of a general pattern (e.g., broadcast according to token XYZ) and the network device performs that action. This is in contrast to the calling process telling the network device how to perform the operation in a step-by-step manner using point-to-point operations. The network offload technique is more efficient than point-to-point techniques if the network hardware supports such network offloading.

With at least some of the illustrative embodiments, the CCPA service informs the network devices of the collective communication pattern, if it is configured to do so. The CCPA service knows from the general network graph, in connection with the collective communication pattern, the set of network devices involved in the collective communication pattern. Each of those network devices may need device specific information about the collective communication pattern to aid in performing collective communication operations using the collective communication pattern.

In some illustrative embodiments, when generating the collective communication pattern, the CCPA service informs all of the involved network devices of the token as well as the associated action they are to perform when a process passes that token with the collective communication operation data. Thereafter, the participating processes may pass the token associated with the collective communication pattern to the network device along with the collective communication operation data. If the network device recognizes the token, then it uses the routing information that the network device has stored about the token to direct the message through the network. If no matching token is registered with the network device, then an error is returned to the calling process indicating that it is an unknown token. The calling process can then send the data of the collective communication operation without the token based optimization.

Since the collective communication pattern generation operation is at least an NP-Hard problem, care is taken to offload as much of the computation as possible. As such, the CCPA service provides parallel applications with the ability to register the previously mentioned “token” with the CCPA service representing the input for the collective communication pattern computation. The CCPA service maintains and updates the collective communication pattern offline in response to network events, e.g., changes in network conditions such as bandwidth, latency, congestion, etc. The parallel application can then use the token to access the current version of the collective communication pattern without waiting for the computation to generate the collective communication pattern.

Parallel applications access the CCPA service via one or more APIs provided by the CCPA service. The APIs may be expressed by several methods, including, but not limited to, a REST interface, protocol over a dedicated socket, or a status bus. A designated process within the parallel application sends the required input to the APIs which returns either a token that can be used by the parallel application later, or the suggested collective communication pattern, e.g., in response to the parallel application sending the token to retrieve the offline computed and stored collective communication pattern.

One example use case of the CCPA service mechanisms may be a Message Passing Interface (MPI) parallel application when an MPI communicator is created. During this time, the parallel application will request tokens for each collective operation that can be performed within the process group defined by the MPI communicator. In generating the tokens, the CCPA service may execute the algorithms for generating the collective communication pattern for the collective operation and may store this collective communication pattern in association with the corresponding token for later use. Thus, for each collective operation, there is an associated token and associated collective communication pattern. The collective communication patterns may be dynamically updated offline, such as in response to network events occurring that change the conditions of the network, with the updated collective communication patterns being stored in association with the previously generated tokens.

When the parallel application calls a specific collective operation on this MPI communicator, the CCPA service is queried passing the associated token. The CCPA service sends back the recommended collective communication pattern for that collective operation. The parallel application may request a new collective communication pattern at the start of each call to that collective operation, or may reuse the previously generated collective communication pattern for some time and periodically update the collective communication pattern over time, either at the call time or in the background.

As touched upon above, the collective communication patterns may be tailored to different types of collective communication operations, e.g., see the discussion of broadcast and scatter operations above. As other examples of such tailoring of the collective communication patterns, consider a reduction collective operation that finds the minimum, maximum, or sum of a distributed set of values. In this collective operation each participating process contributes a value that will be combined (via a reduction operator) with the other values at other processes to produce a result. The final result can be sent to a single process (e.g., MPI_Reduce) or to all participating processes (e.g., MPI_Allreduce).

Depending on whether the collective operation is rooted or not, the size of the operation, and if the operation is commutative, different mapping patterns can be generated by different mapping algorithms for the collective communication of this collective operation. One such mapping algorithm may organize the participants in a tree sending up the tree to a root and performing the reduction operator at each child in the tree. Another pattern may use a recursive doubling technique which operates in rounds between pairs of processes organized in a ring. Depending on different factors and multidimensional weightings of edges in the corresponding graph data structures, in accordance with the illustrative embodiments, one mapping of a collective communication pattern may be better than another, as may be determined through scoring based on a theoretical model, for example. The CCPA service of the illustrative embodiments evaluates each of the candidate collective communication patterns and selects the best candidate for the current network conditions and provides that collective communication pattern to the participants for improving the collective communication of the collective operation.

Thus, the illustrative embodiments provide an improved collective communication pattern advisor (CCPA) service computing tool and computing tool operations/functionality that implements a multidimensional network edge weighting mechanism to perform collective communication pattern recommendation generation that identifies the most efficient collective communication patterns tailored to specific collective operations. The CCPA service maintains and updates the network edge weight annotations in response to network events causing changes in the factors that are used to generate these edge weight annotations. The CCPA service provides parallel applications with the ability to offload the computation of the collective communication pattern in exchange for a “token” that can be used to query the collective communication pattern later. Based on the occurrence of network events, the CCPA service will periodically update stored collective communication patterns (associated with a token) so as to keep the collective communication patterns current to the most recent network conditions and thus, provide the determined most efficient collective communication patterns to collective operation participants in response to requests using the corresponding tokens.

The inclusion of the mechanisms of the illustrative embodiments into network manager products or the implementation of the mechanisms of the illustrative embodiments in conjunction with such network manage products provides collective communication pattern advice to parallel applications and network services to improve the efficiency of these parallel applications and network services and thereby enhance the performance of collective computing operations. Any computer applications or processes that rely on collective communications to perform collective operations may be improved by the mechanisms of the illustrative embodiments as the illustrative embodiments will inform them of the most optimal pathways of communication given the current network conditions, the multi-dimensional weighting, and relative priority or importance to the specific type of collective communication operation being performed. For example, libraries that provide collective APIs can leverage the CCPA service to enhance their collective algorithms making them more tolerant of network performance fluctuations. Any Message Passing Interface (MPI) implementation may use the CCPA service to improve their collective performance. In addition, various Application Performance Monitoring (APM) services, such as IBM Instana™ APM, and IBM Netcool Operations Insight™ suite, both available from International Business Machines (IBM) Corporation of Armonk, New York, may be enhanced by incorporating the CCPA service of one or more the illustrative embodiments.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a collective communication pattern advisor (CCPA) service. The improved computing tool implements mechanism and functionality, such as the CCPA service engine, which cannot be practically performed by human beings either outside of, or with the assistance of, a technical environment, such as a mental process or the like. The improved computing tool provides a practical application of the methodology at least in that the improved computing tool is able to generate collective communication pattern recommendations for collective communications of collective operations based on network conditions and the prioritization of network condition factors for different collective communications so as to improve the efficiency of the collective communications, e.g., broadcast, scatter, gather, etc., and collective operations of a parallel application.

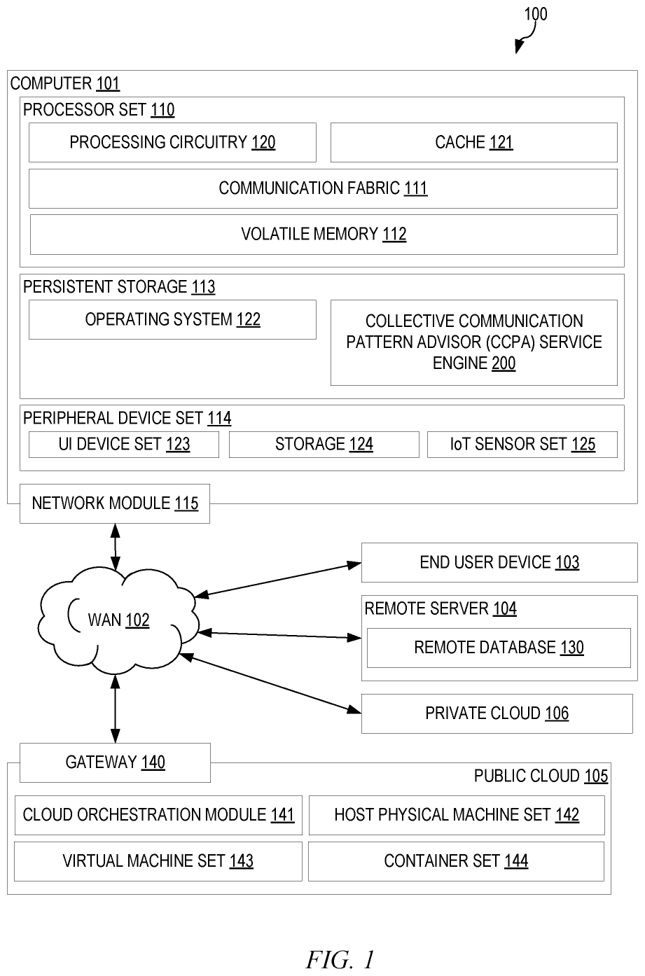

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as collective communication pattern advisor (CCPA) service engine 200. In addition to the CCPA service engine 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and CCPA service engine 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the CCPA service engine 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in CCPA service engine 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement the CCPA service engine 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates collective communication pattern recommendation generation for collective communication operations based on current network conditions and the collective communication operation being performed.

FIG. 2 is an example diagram of a collective communication pattern advisor (CCPA) service engine in accordance with one or more illustrative embodiments. The CCPA service engine 200 comprises a network interface 202, one or more APIs 204, a multi-dimensional edge weight annotation engine 206, a spanning subgraph generator 208, a collective communication prioritization engine 210, collective communication prioritization rules storage 212, collective communication pattern recommendation generator 214, and collective communication pattern storage 216. The CCPA service engine 200 provides the CCPA service to one or more computing devices, e.g., servers 222-232 and pass-through devices, e.g., switches and routers, 234-238, of the cluster 220. The computing devices 222-232 may access the CCPA service via the one or more APIs 204 and be provided with a collective communication pattern recommendation via these one or more APIs 204. For example, the computing devices 222-232, in response to a parallel application executing on a computing device, e.g., client process executing on server 222, initiating a collective communication operation with other devices of the cluster 220, may send a query or request via an API call of the API 204 specifying a previously provided token to thereby obtain the current collective communication pattern recommendation for that type of collective communication. The CCPA service engine 200 may process the token and retrieve the corresponding collective communication pattern from a collective communication pattern storage 216 and return the collective communication pattern to the requesting computing device 222 which may then utilize that collective communication pattern to perform the collective communication operation with the other devices of the cluster 220 that are part of the collective operation.

The network interface 202 provides a data communication interface for communicating with various computing devices via one or more data networks 270. In particular, the network interface 202 provides a data communication interface through which the CCPA service engine 200 communicates with a network monitoring service 240 that is the source of a network graph data structure 250 representing the computing devices of the monitored network, e.g., cluster 220. It should be appreciated that while FIG. 2 shows the network monitoring service 240 as a separate service from that of the CCPA service engine 200, in some illustrative embodiments, these services may be integrated into a network management product. Moreover, in some illustrative embodiments, in which a network monitoring service 240 is not available, the CCPA service engine 200 may be enhanced to include network graph data structure generation in accordance with one or more known or later developed algorithms.

As shown in FIG. 2, the network monitoring service 240, or in an alternative embodiment, the CCPA service engine 200 itself, accesses the physical and logical network topology 260 of the monitored network, e.g., cluster 220. The network monitoring service 240 and/or CCPA service engine 200 also obtains common performance characteristics of all network devices, i.e., network attached computing devices 222-232 of the monitored network, e.g., cluster 220. Changes in these common performance characteristics may be considered network events 262, e.g., changes in latency, bandwidth, congestion, etc. For example, in some illustrative embodiments, network monitoring services 240 may include a monitoring protocol such as Link Layer Discovery Protocol (LLDP) and Simple Network Management Protocol (SNMP), which provide network monitoring information that can be aggregated into a logically centralized data store, such as via an aggregation service, e.g., Prometheus or Elasticsearch. Such aggregation services also provide triggers that can be called when certain network events 262 occur, so that, for example, a graph view of the network, e.g., cluster 220, can be updated by the CCPA service engine 200 as such network events 262 occur.

In some illustrative embodiments, the network monitoring service 240 may comprise a Skydive Kubernetes mechanism which provides a real-time network topology view and protocol analysis tools based upon this information and information about Software Defined Network (SDN) flows. The analysis in Skydive is limited to point-to-point flows in the monitored network, but this mechanism does provide access to a graph via an Application Programming Interface (API). The CCPA service engine 200 of the illustrative embodiments can use the network update events 262 from the aggregated data store and either augment the graph data structure 250 supplied by Skydive (or a similar service, such as an Application Performance Monitoring (APM) mechanism) to enhance that product or consume the Skydive graph data structure 250 to provide a more accurate representation of the network for internal use by the CCPA service engine 200 algorithms.

In some illustrative embodiments, the network monitoring service 240 may comprise an Application Performance Monitoring (APM) mechanism, such as the IBM Netcool Operations Insight suite. The IBM Netcool Operations Insight suite has two components that provide a graph view of the current network conditions. The IBM Tivoli Network Manager provides network discovery and network event reporting. The IBM Netcool Agile Service Manager (ASM) aggregates and overlays this data into a searchable graph data structure.

The CCPA service engine 200 of the illustrative embodiments may either leverage the graph data structure 250 from the network monitoring service 240, or may be integrated into the network monitoring service 240, to provide collective communication pattern advice for a client computing device, e.g., a server 222-232 that request to initiate a collective communication operation. To augment the IBM Netcool Operations Insight suite, for example, the CCPA service engine 200 of the illustrative embodiments may take as input, the constraints on the collective operation, analyzes the graph data structure 250 representation of the data network elements and communication pathways corresponding to a collective operation, and produces a collective communication pattern that the client computing device can use to perform a specific collective operation efficiently (e.g., broadcast, scatter, reduce, barrier, and the like) given the current state of the network.

Regardless of the source of the network graph data structure 250, the CCPA service engine 200 comprises logic, e.g., algorithms or the like, which operate on the graph data structure 250 to identify, for a given collective communication operation type, a corresponding collective communication pattern recommendation. The CCPA service engine 200 may generate such collective communication pattern recommendations as an offline process and store these collective communication patterns in association with a generated token for the particular collective communication operation type. A set of collective communication operation types and corresponding tokens and collective communication patterns may be stored for each different parallel application requesting collective communications. Thus, the collective communication pattern storage 216 may have multiple sets of mappings for multiple different parallel applications, each having multiple tokens and corresponding collective communication patterns, e.g., one pair for each type of collective communication that can be performed by that parallel application. The CCPA service engine 200 may further update the already stored collective communication patterns in response to network events 262 causing changes in performance characteristics of the connections between network components, e.g., computing devices 222-232 of the cluster 220.

Thereafter, during an online operation, a parallel application executing on a computing device, e.g., server 222, may send a request or query to the CCPA service engine 200 by calling the API 204 and specifying the token. Based on the received token, a lookup of the corresponding collective communication pattern may be performed by the CCPA service engine 200 in the collective communication pattern storage 216 and the corresponding collective communication pattern returned to the requesting computing device for use in performing the collective communication operations.

In generating the collective communication patterns, as part of an offline process, or even as part of an online process in response to a request or query from a computing device for a collective communication pattern in some illustrative embodiments, the CCPA service engine 200 implements a multi-dimensional weighting, spanning subgraph generation, and collective communication operation prioritization, to identify the optimal collective communication pattern given the current network conditions of the monitored network, e.g., cluster 220. That is, in a first step of the operation (step 1 in the graph flow shown in FIG. 2), the CCPA service engine 200 receives the network graph data structure 250 from a network monitoring service 240 via the network interface 202 and/or APIs 204, or otherwise generates the network graph data structure 250 based on network topology and network events 260-262.

In a second operation (step 2 in the graph flow shown in FIG. 2), the edges of the network graph data structure 250 are weighted by the multi-dimensional edge weighting engine 206 based on a plurality of different network performance factors, e.g., latency, available bandwidth, congestion, etc., and based on other factors such as usage, process affinity, and historical data, as discussed previously, which may be obtained as part of network events 262 or otherwise received from the network monitoring service 240, for example. The result is a weighted graph data structure 280 in which the edges of the graph data structure 250 have been annotated to include a multi-dimensional weight annotation. At this point, a multi-dimensionally weighted graph data structure is generated that may be applicable to all collective communication types for all parallel applications in the monitored network, e.g., cluster 220. Thus, this weighted graph data structure 280 may serve as a basis for the generation of multiple different collective communication patterns for different collective communication operation types of different parallel applications.

Due to the significant impact of edge weighting on the efficiency of collective communication pattern mapping algorithms of the illustrative embodiments, with the mechanisms of the CCPA service engine 200, as network events occur (such as changes in state causing latency variations, packet drop rates, network congestion levels, error rates, and the like), this network monitoring information is annotated on the impacted edge of the weighted graph data structure 280. This annotation is a multidimensional characterization of the performance and stability of the edge, where the edge represents a communication pathway between two components or entities of the network, e.g., cluster 220. Keeping a history of prior values of these factors of this multidimensional network monitoring information can be used to predict future behavior, such as in the case of the historical data previously mentioned above. Such predictions may be performed, for example, by a trained Recurrent Neural Network (RNN) or other artificial intelligence (AI) computing model, to detect network anomalies and improve a website's reliability.

Network switches that employ adaptive routing techniques may share congestion information between switches and thus, may utilize a spanning subgraph such as that provided by the mechanisms of the illustrative embodiments, to choose between different spanning subgraphs to route a message. Software Defined Networking (SDN) flows and Quality of Service (QOS) features in the switches can provide enhanced priority for certain data packets moving through the network. Network measurement techniques may make use of tools to measure network latency between two endpoints to estimate the latency of various links over time. All these techniques are focused on characterizing the performance and reliability of a link between two network entities and may be utilized to provide the network events 262 and performance information for weighting edges in the network graph data structure 280 and the spanning subgraph.

The CCPA service engine 200 of the illustrative embodiments utilize weights on the edges that account for some or all of these data points to assist the collective communication pattern mapping algorithms in determining the best collective communication pattern for a given collective communication operation at that point in time. Once an undirected and weighted graph of the network 250 is created and maintained using the techniques mentioned above, utilizing the logic of the multi-dimensional edge weighting engine 206, the spanning subgraph generator 208 identifies the spanning subgraph corresponding to the collective communication operation sought to be performed. That is, the spanning subgraph generator 208 identifies the collective communication operation that is to be performed, based on the parallel application's specification of the collective communication operation to be performed, i.e., the call from the client device/process to the API 204 includes a specification of the type of collective communication as well as the participants in the collective communication which informs the spanning subgraph generator 208 of the corresponding subgraph corresponding to the collective communication operation. Thus, the spanning subgraph generator 208 identifies which nodes in the weighted graph data structure 280 that are involved in the particular collective communication operation. This is shown in FIG. 2 as step 3 of the graph flow and results in the weighted subgraph 282.

The weighted subgraph 282 only includes the specified set of client devices/processes, since they are the only messaging actors in the collective operation. This weighted subgraph 282 is the basis for generating a collective communication pattern for the collective communication operation, where the weighted subgraph 282 specifies the weights of edges between the elements, nodes, which are the messaging actors of the collective operation, where messaging actors may have multiple different paths, and paths with multiple edges, to communicate with one another. The weights are multi-dimensional weights based on the current, or most recently reported, network conditions of the cluster 220.

Thus, the CCPA service engine 200 produces a collective communication pattern based on the current network conditions combined with the input provided regarding the collective communication. The weighted subgraph 282 may be further analyzed by the collective communication operation pattern generator 214 to generate a specific collective communication operation pattern. For example, the collective communication operation pattern generator 214 operates, in some illustrative embodiments, to generate the collective communication pattern by first taking the spanning subgraph 282 of the broader network/cluster graph data structure 280, and finding the combination of edges in the spanning subgraph 282 that has the least accumulated weight, but which connects all of the messaging actors. That is, the collective communication pattern comprises the nodes of the general graph data structure 280 of the network/cluster 280, that are the message passing actors for the particular collective operation, and the edges between these nodes that have the least weight.

The collective communication operation pattern generator 214 may operate in conjunction with the collective communication operation prioritization engine 210 to perform such prioritization evaluations of edges based on a set of prioritization rules 212. These prioritization rules 212 may specify various types of prioritization criteria depending on the desired implementation, only one of which may be to find the smallest weight edges. Other prioritization criteria may be used without departing from the spirit and scope of the present invention. For example, different prioritization rules may be used depending on the type of collective communication operation that is to be performed. That is, the requirements of the particular collective operation may also be taken into consideration when selecting the edges between the nodes, such as those requirements mentioned above, e.g., a small message broadcast operation may prioritize edges with smaller latency weights since it is more latency-bound and benefits from consistent small message performance, whereas a large message scatter operation may prioritize edges with small bandwidth weights since such operations are more bandwidth-bound and benefit from edges in the collective communication pattern that do not overlap and have reduced contention on network resources.

Thus, based on the prioritization rules 212 that correspond to the particular collective communication operation for which the collective communication patterns is to be generated, the collective communication operation prioritization engine 210 prioritizes different edges based on their particular weighting characteristics.

The prioritization rules 212 specify which factors to weight more heavily or less heavily for corresponding collective communication operations. These prioritization rules 212 may be defined by an administrator of the network/cluster 220, or other authorized personnel, and may be updated as needed. Thus, there may be one or more prioritization rules 212 for each type of collective communication operation, e.g., broadcast, scatter, gather, data sharing, and distributed mathematical operations, etc.

The CCPA service engine 200 of the illustrative embodiments creates a collective communication pattern (e.g., a tree topology, a ring topology, or the like) over that network/cluster 220 that will provide the client computing devices, or processes, with the best possible performance with respect to the current network conditions for a given set of peer computing devices or processes and with respect to the particular type of collective communication operation that is to be performed between these messaging actors. One option for generating a tree structure is to utilize a Minimum Spanning Tree (MST), which defines a spanning tree in which the sum of the weights of the edges is minimized. Exact or approximate algorithms for generating an MST may be utilized. Other tree structures, such as a Binomial Tree which is designed to increase the amount of point-to-point concurrency in a collective operation, may be utilized as well. Any suitable collective communication pattern generating algorithm (i.e., not limited to tree structures) may be used without departing from the spirit and scope of the present invention.

Research into optimal collective communication patterns for specific collective operations, in particular, regular and irregular gather and scatter operations, show that even accounting for static network conditions, the optimal communication pattern may not be regular in shape because the optimal communication pattern must adapt to heterogenous network topology and, in specific collectives, the amount of data exchanged increases near the root of the operation. The CCPA service engine 200 of the illustrative embodiments is agnostic to the exact algorithm employed to generate the resulting collective communication pattern as different algorithms may be more appropriate for different collective operations that are to be performed. As such, in some illustrative embodiments, the CCPA service engine 200 incorporates a variety of such algorithms connected to specific collective operations.

In addition to the above, Process-level QoS to Message Passing Interface (MPI) jobs that direct the network to prioritize point-to-point patterns for a given application may be implemented with the mechanisms of the illustrative embodiments. With such mechanisms, a trace of a distributed application is provided to a resource manager (not shown) of the network monitoring service 240 on the next run of a job. The resource manager then uses this trace to pick the most used routes and make a QoS request to the network manager (not shown) of the network monitoring service 240. The CCPA service engine 200 of the illustrative embodiments may use such a technique to establish Quality of Service (QOS) requests or Software Defined Network (SDN) flows through the network/cluster 220 relative to the returned collective communication pattern and prioritize the edges of these SDN flows when generating the collective communication pattern.

The collective communication pattern generator 214 may store the collective communication pattern, generated based on the weighted subgraph 282 and the application of prioritization rules 212 by the prioritization engine 210 (see step 4 in FIG. 2), in a pattern database 216 in association with a token which may be used to retrieve the collective communication pattern at a later time. The token may be broadcast to the messaging actors of the collective communication operation along with the collective communication pattern, such that the token is stored locally by these messaging actors. The token may then be used at a later time to obtain the most current collective communication pattern for the given collective communication operation. Thus, when a subsequent request is made to perform the collective communication operation, the token may be passed with the request and the token may be used by the collective communication operation pattern generator 214 to search for a corresponding entry in the collective communication pattern storage 216. If a matching token is found in the storage 216, the current collective communication pattern may be returned to the requestor and/or all messaging actors of the collective communication operation. Moreover, as network events occur, the collective communication patterns affected by the network events may be updated to the most current conditions of the network/cluster 220 and stored in association with their previously generated tokens.

In some cases, each type of collective communication operation may be the basis of an offline determination of a collective communication pattern to generate patterns for each type of collective communication operation for a given network/cluster 220 and/or set of messaging actors within the given network/cluster 220. These offline generated patterns may be stored with corresponding tokens and the tokens sent to the messaging actors of the particular patterns. Then, the messaging actors, when initiating a collective communication operation, may send the token to the CCPA service engine 200 which returns the collective communication pattern associated with that token.

Thus, the CCPA service engine 200 may inform network devices, e.g., servers 222-230 and/or pass-through devices 234-238 in the network/cluster 220 of the collective communication pattern to improve the quality of service within the network/cluster 220 once the CCPA service engine 200 has established a collective communication pattern. This is shown in FIG. 2 as step 5 of the graph flow. Thus, when a messaging actor, e.g., a server 222, wishes to perform a collective communication operation, the server 222 may request the collective communication pattern from the CCPA service engine 200. If this is the first request for such a collective communication pattern, and a previous offline generated collective communication pattern has not already been generated for this collective communication operation, then the CCPA service engine 200 may generate the collective communication pattern based on the process discussed above, with appropriate prioritization of edges based on applicable prioritization rules 212, and stores this collective communication pattern in association with a token which is returned to the server 222 along with the collective communication pattern. In some cases, the token and collective communication pattern may be broadcast to all of the messaging actors, e.g., others of the servers 224-230, at this time as well. If this is not the first request, then the server 222 will have a stored token which it passes with the request and the token is used to retrieve a corresponding collective communication pattern from the stored patterns in storage 216. These stored patterns may be periodically updated, such as in response to reported network events, so as to maintain them as current as possible.

Moreover, the network pass-through devices 234-238 may be updated with current collective communication patterns periodically so as to keep their routing and switching logic up to date with current network/cluster conditions. For example, with regard to the pass-through devices 234-238, the CCPA service engine 200 may broadcast or otherwise transmit to each of the switches, routers, and other computing devices of the spanning subgraph, the collective communication pattern. These network pass-through devices 234-238 may then utilize this collective communication pattern when performing the switching and routing of data communications within the network so as to utilize the pathways specified when routing data packets from and to the various message passing actors of the collective operation. This may be done when updates to the collective communication pattern are generated as well, so that the switches, routers, and other computing devices are informed of changes to the collective communication patterns in response to these network events.

Thus, the illustrative embodiments provide an improved computing tool and improved computing tool operations/functionality for generating and distributing collective communication patterns for optimizing collective communications between messaging actors given a multi-dimensional weighting of communication pathways and prioritization based on the types of collective communications being performed. Hence, with the mechanisms of the illustrative embodiments, collective communication operations of parallel applications are improved by using the most efficient collective communication pathways within a network/cluster between the messaging actors given the current conditions of the network/cluster and the prioritization of different criteria that maximize the efficiency of the particular collective communication operation.

The illustrative embodiments provide a collective communication prioritization advisor service that is not limited by switch capacity and does not require specialized switches to operate, allowing the illustrative embodiments to work in any network architecture. The illustrative embodiments account for other network conditions (as described in the edge weighting discussion above) to provide more accurate information to the CCPA service engine's collective communication pattern generation. The illustrative embodiments provide mechanisms that may enhance other collective operation services at least by providing additional weight information and accounting for other data sources while maintaining a network/cluster graph. Further, the illustrative embodiments provide mechanisms for querying the collective communication pattern for a collective communication operation, via a token based search of stored collective communication patterns, which improves the responsiveness of collective communication operations at least by reducing latency due to determination of collective communication patterns.

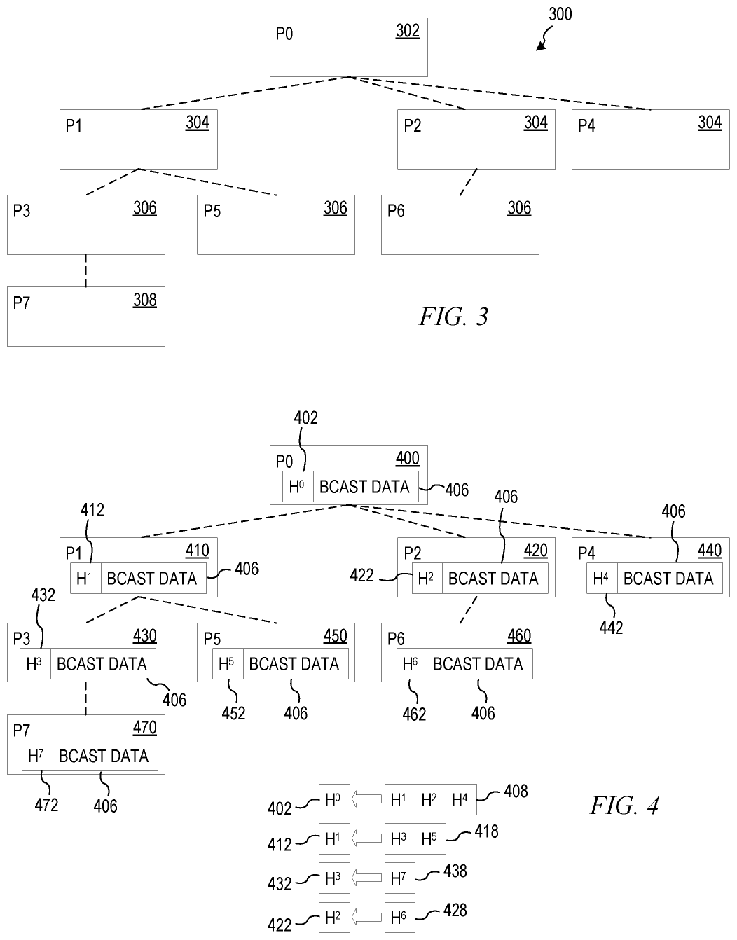

FIG. 3 is a block diagram of an example collective communication pattern, shown as a tree structure, which may be generated by the CCPA service engine in accordance with one or more illustrative embodiments. In some illustrative embodiments, the tree structure 300 includes a root node 302, also referred to as an origin node or origin participant, and a plurality of child nodes 304, also referred to as participant nodes. As shown, one or more of the plurality of child nodes 304 can have child nodes 306 that descend from child node 304, and child nodes 306 can have child nodes 308 that descend from child node 306. In some illustrative embodiments, each of the nodes (root node 302 and child nodes 304, 306, and 308) may be embodied in a computer, e.g., server 222-230, as shown in FIG. 2, for example.

In some illustrative embodiments, prior to initiating a collective communication operation, such as a broadcast or scatter operation, the origin participant 302 obtains a tree structure 300, from the CCPA service of the illustrative embodiments, that will be used for performing the collective communication operation. In one illustrative embodiment, the tree structure 300 is only known by the origin participant 302 and not the other participant nodes. In other illustrative embodiments, the tree structure 300 is provided to each of the origin participant 302 and the other participant nodes.

In some illustrative embodiments, the tree structure 300 may differ per collective communication operation being performed, even to the same set of participants, depending on the network conditions, the collective communication operation being performed, and other prioritization criteria. The tree structure 300 does not need to be in a regular pattern but can be irregular based on external input, such as network conditions. The process, and mechanisms invoked, for creating the tree structure 300 may comprise one or more of the illustrative embodiments previously described with regard to the elements of FIG. 2, for example. That is, the tree structure 300 may be a collective communication pattern as generated by the CCPA service engine 200 based on a generation of the weighted subgraph and prioritization of edges of the weighted subgraph in accordance with the illustrative embodiments previously described. The collective communication pattern may then be output to one or more nodes, e.g., computing devices, of the corresponding network/cluster 220 as the tree structure 300. Again, this may be in response to a token based search of the storage 216 in some cases.

FIG. 4 is a block diagram of an example broadcast operation that may be performed using the collective communication pattern of FIG. 3 in accordance with one illustrative embodiment. It should be appreciated that while the broadcast operation described in the co-pending application will be used as an example, the illustrative embodiments are not limited to such and may be used with any collective communication operation and parallel application performing such collective communication operation, e.g., other types of broadcast operations, without departing from the spirit and scope of the present invention.

As shown in FIG. 4, in such a broadcast operation, the origin participant 400 adds a header 402 to the message payload in a well-known location either before or after the message payload 406. The header 402 describes the base address of the data payload 406, length of the data payload 406, and subtree structure 408 for the receiving participant (“child”). As illustrated, the headers 412, 422, 442 transmitted to child nodes 410, 420, 440, respectively, are different from one another, as each includes a different subtree structure 408 generated based on the collective communication pattern, e.g., the tree structure 300 in FIG. 3, which may be the collective communication pattern 284 in FIG. 2. In some illustrative embodiments, a cached subtree structure is used, e.g., cached in collective communication pattern storage 216 of FIG. 2, and a marker or token identifying that cached subtree is sent instead of the subtree structure for the receiving participant. The marker or token may then be used to retrieve the subtree structure from the storage 216 by querying or sending a request to the CCPA service engine 200, for example.

In some illustrative embodiments, once the origin participant 400 has assembled the data payload 406 and headers, the origin participant 400 starts the broadcast operation. The origin participant 400 transmits the header 412 and the data payload 406 to child node 410, the header 422 and data payload 406 to child node 420, and the header 442 and data payload 406 to child node 440.

In some illustrative embodiments, a child participant will receive the data payload from their parent, which is unknown to them before the start of the messaging protocol. The child participant will inspect the data payload to discover the structure of the data payload and the form of the subtree below them, if any. In some illustrative embodiments, when a child participant receives the header and data payload 406, the child participant prunes the header of subtree information that does not pertain to the subtree to which they are sending and transmits a new header and data payload to its child nodes.

For example, after node 410 receives header 412 and data payload 406, the node 410 will prune the header 412 to create header 432 and header 452, which are respectively transmitted to nodes 430 and 450, along with the data payload 406. If the child is a terminal node, such as node 470, then the propagation of the payload data 406 terminates. If an acknowledgment is requested, then each node transmits an acknowledgment message to its immediate parent, i.e., to whom it received the message. If the child is non-terminal, and an acknowledgment is requested, then the node will wait until receiving acknowledgment messages from its subtree before forwarding that acknowledgment to its immediate parent for that message. In some illustrative embodiments, the propagation pattern continues until all participants have received the data payload destined for them and sent any acknowledgment required.

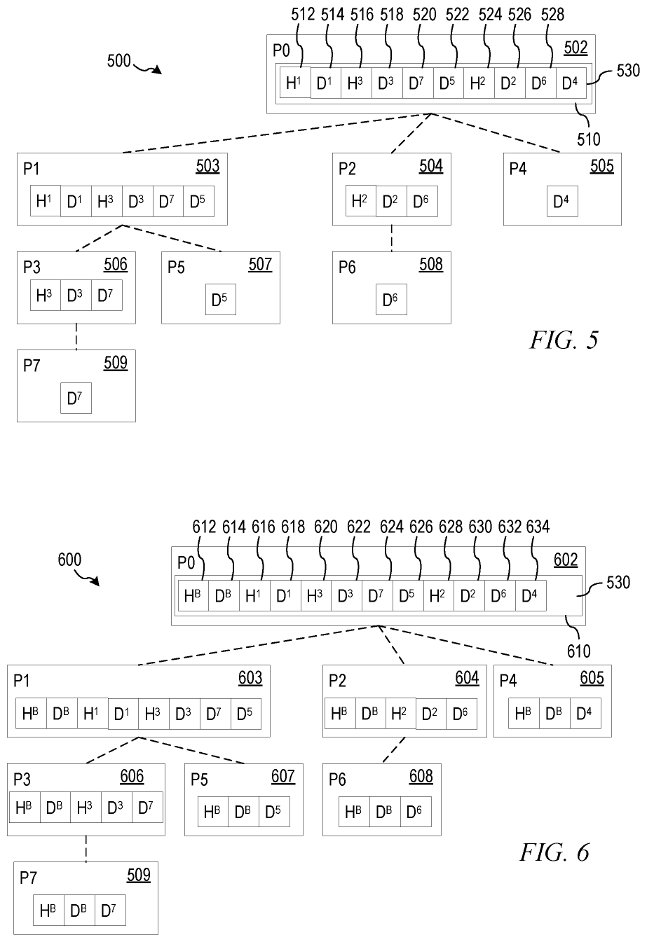

FIG. 5 is a block diagram of an example scatter operation that may be performed using the collective communication pattern of FIG. 3 in accordance with one illustrative embodiment. It should be appreciated that while the scatter operation described in the co-pending application will be used as an example, the illustrative embodiments are not limited to such and may be used with any collective communication operation and parallel application performing such collective communication operation, e.g., other types of scatter operations, without departing from the spirit and scope of the present invention.

As shown in FIG. 5, in one or more illustrative embodiments, when the origin participant 502 initiates a scatter operation 500, the origin participant 502 obtains a tree structure, e.g., collective communication pattern such as that generated by the CCPA service engine 200 in FIG. 2 in accordance with one or more illustrative embodiments, which is to be used for the scatter operation 500. The tree structure includes a plurality of nodes 503, 504, 505, 506, 507, 508 and 509.

After the tree structure is obtained, the origin participant 502 creates a message 510 that includes multiple headers 512, 516, 524, and multiple data payloads 514, 518, 520, 522, 526, 528, and 530. In some illustrative embodiments, the origin participant 502 creates a data payload 514, 518, 520, 522, 526, 528, and 530 for each node 503, 504, 505, 506, 507, 508 and 509 in the tree structure, e.g., the collective communication pattern. Likewise, the origin participant 502 creates a header 512, 516, and 524 for each node 503, 506, and 504 of the tree structure that has at least one child node. In some illustrative embodiments, the header 512, 516, 524 for each node 503, 506, and 504 includes a description of the sub-tree of the tree structure that descends from the node 503, 506, and 504. The header 512, 516, and 524 may also describes the base address of the data payloads 514, 518, 520, 522, 526, 528, and 530, and the length of the data payloads 514, 518, 520, 522, 526, 528, and 530.

In some illustrative embodiments, the message 510 is created by the origin participant 502 such that the portions of the message 510 that will be transmitted to each child node are contiguous. For example, as illustrated, the headers 512 and 516, and data payloads 514, 518, 520, and 522 that are transmitted to child node 503 are contiguous. Likewise, header 524 and data payloads 526 and 528, that will be transmitted to child node 504, are contiguous. In one embodiment, a cached subtree structure, such as the stored collective communication pattern in storage 216 of FIG. 2, is used and a marker or token identifying that cached subtree is sent instead of the subtree structure for the receiving participant. The marker or token may then be used to retrieve the subtree structure from the storage 216 by querying or sending a request to the CCPA service engine 200, for example.

Once a child node receives a portion of the message 510, the child node is configured to extract the data needed by the child node and split the remaining headers and data payloads using the information from the header for the child node. For example, once child node 503 receives the portion of the message from the origin participant 502, child node 503 extracts the data payload 514 needed by child node 503 and uses the information in header 512 to separate the remaining portion of the message 510 into separate parts. The child node then propagates a portion of the message, i.e., it only sends the subset of the headers and data payloads destined for a specific subtree to that subtree. For example, child node 503 transmits header 516 and data payloads 518 and 520 to child node 506 and data payload 522 to child node 507.

FIG. 6 is a block diagram of an example combination broadcast/scatter operation that may be performed using the collective communication pattern of FIG. 3 in accordance with one illustrative embodiment. It should be appreciated that while the combination broadcast/scatter operation described in the co-pending application will be used as an example, the illustrative embodiments are not limited to such and may be used with any collective communication operation and parallel application performing such collective communication operation, e.g., other types of combination broadcast/scatter operations, without departing from the spirit and scope of the present invention.

As shown in FIG. 6, in one or more illustrative embodiments, when the origin participant 602 initiates a combination broadcast/scatter operation 600, the origin participant 602 obtains a tree structure to be used for the combination broadcast/scatter operation 600, e.g., a collective communication pattern such as generated by the CCPA service engine 200 of FIG. 2. The tree structure includes a plurality of nodes 603, 604, 605, 606, 607, 608 and 609. After the tree structure is obtained, the origin participant 602 creates a message 610 that includes a broadcast header 612, a broadcast data payload 614, multiple scatter headers 616, 620, and 628, and multiple scatter data payloads 618, 622, 624, 626, 630, 632, and 634. In some illustrative embodiments, the origin participant 602 creates a scatter data payload 618, 622, 624, 626, 630, 632, and 634 for each node 603, 604, 605, 606, 607, 608 and 509 in the tree structure. Likewise, the origin participant 602 creates a scatter header 616, 620, and 628 for each node 603, 604, and 606 of the tree structure that has at least one child node. In some illustrative embodiments, the scatter header 616, 620, and 628 for each node 603, 604, and 606 includes a description of the sub-tree of the tree structure that depends on the node 603, 604, and 606. The scatter header 616, 620, and 628 may also describes the base address of the scatter data payloads 618, 622, 624, 626, 630, 632, and 634, and the length of scatter data payloads 618, 622, 624, 626, 630, 632, and 634.

In some illustrative embodiments, the message 610 is created by the origin participant 602 such that the portions of the message 610 that will be transmitted to each child node are contiguous. For example, as illustrated, the headers 616 and 620, and data payloads 618, 622, 624, and 626 that will be transmitted to child node 603, are contiguous. Likewise, header 628 and data payloads 630 and 632 that will be transmitted to child node 604, are contiguous.

Once a child node receives a portion of the message 610, the child node is configured to inspect the header corresponding to the child node to discover the structure of the data payload and the form of the sub-tree below the child node, if any. The child node is further configured to extract a copy of the broadcast payload 614 for its consumption and to remove the scatter payload that corresponds to the child node. For example, child node 603 will inspect the broadcast header 612 and extract a copy of the broadcast payload 614 and inspect the scatter header 616 and extract the scatter payload 618. Based on the information in the broadcast header 612 and the scatter header 616, the child node 603 will create and transmit messages to child nodes 606 and 607.

In some illustrative embodiments, the child node only propagates a portion of the message to each child node that depends from it, i.e., the child node only sends the subset of the headers and data payloads destined for a specific subtree to that subtree. For example, child node 603 transmits broadcast header 612, broadcast data payload 614, scatter header 620 and scatter data payloads 622, 624 to child node 606 and broadcast header 612, broadcast data payload 614, and scatter data payload 626 to child node 607.

In some illustrative embodiments, each child node may be configured to add additional data to the header and/or data payload that are propagated to its subtree. In addition, each child node may be configured to alter the tree structure for its subtree. For example, a child node may have knowledge that a node in its subtree is offline or having an unexpected performance issue, in this case, the child node may replace that node in its subtree with a different node.

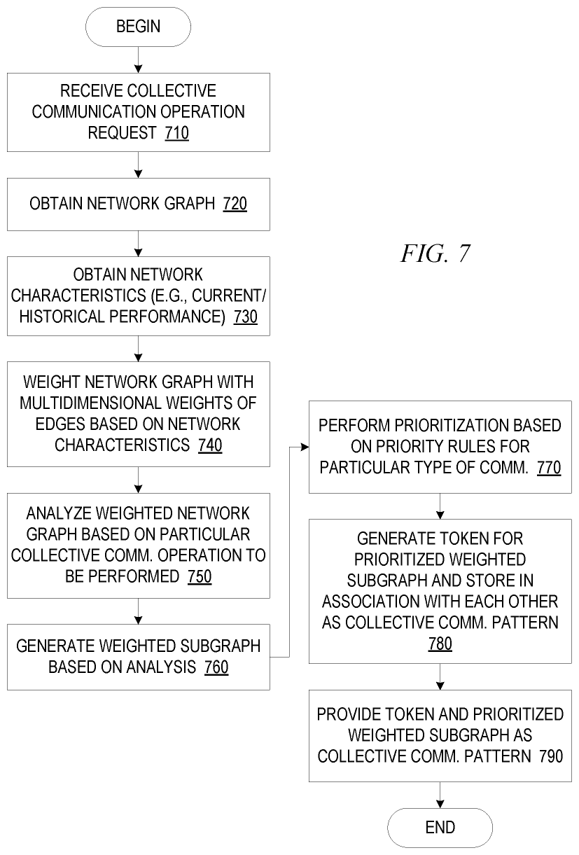

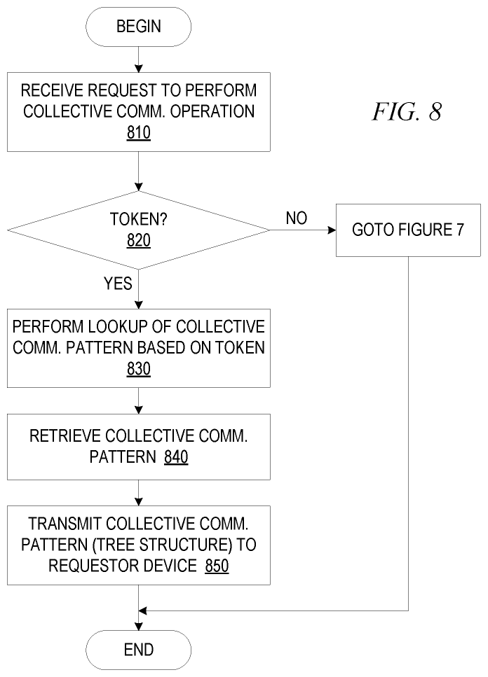

FIGS. 7-10 present flowcharts outlining example operations of elements of the present invention with regard to one or more illustrative embodiments. It should be appreciated that the operations outlined in FIGS. 7-10 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 7-10, and may, in some cases, make use of the results generated as a consequence of the operations set forth in FIGS. 7-10, the operations in FIGS. 7-10 themselves are specifically performed by the improved computing tool in an automated manner.

FIG. 7 is a flowchart outlining an example operation for generating a collective communication pattern recommendation in accordance with one illustrative embodiment. The operation outlined in FIG. 7 may be used to generate a collective communication pattern that may be utilized as the tree structure for the broadcast, scatter, and/or combined broadcast/scatter operations described with regard to FIGS. 4-6, for example, or other collective communication operations.

As shown in FIG. 7, the operation starts by receiving a request, from a parallel application, for a collective communication pattern for performance of a collective communication operation (step 710). This request may be received, for example, as an API call to the CCPA service engine 200 for example. A network graph data structure for the network is obtained, either from a locally stored network graph data structure or from a remotely located network monitoring service, for example (step 720). Network characteristics are obtained from the network or a network monitoring device (step 730) where these network characteristics may include current and/or historical data about the performance of the network with regard to nodes and links between nodes in the network. The network characteristic data is then used to weight the network graph data structure with multi-dimensional weights on edges of the network graph data structure (step 740) to generate a weighted network graph data structure.

The weighted network graph data structure is then analyzed based on the particular collective communication operation that is to be performed, as specified in the received request (step 750). Based on the collective communication operation, a weighted subgraph is extracted from the network graph data structure (step 760) based on the analysis performed. Edges of the weighted subgraph are then prioritized based on prioritization rules for the particular collective communication operation (step 770) to generate a prioritized weighted subgraph. A token for the prioritized weighted subgraph is generated and the prioritized weighed subgraph is stored as a collective communication pattern in association with the token (step 780). The token and collective communication pattern are returned to the requestor computing device which stores the token for later use in subsequent request for collective communication operations with the same cluster of nodes and same collective communication operation (step 790). The operation then terminates.

FIG. 8 is a flowchart outlining an example operation for providing a collective communication pattern recommendation in response to a token based request or query in accordance with one illustrative embodiment. As shown in FIG. 8, the operation starts by receiving a request to perform a collective communication operation, such as via an API call or the like (step 810). A determination is made as to whether the request includes a specified token or not (step 820). If the request does not include a specified token, then the operation goes to FIG. 7 where the collective communication pattern process is followed starting at step 710. If the request does include a specified token, the token is used as a basis for performing a lookup operation in a database of stored collective communication patterns (step 830). The corresponding collective communication pattern is retrieved (step 840) and transmitted to the requestor computing device (step 850). The operation then terminates.

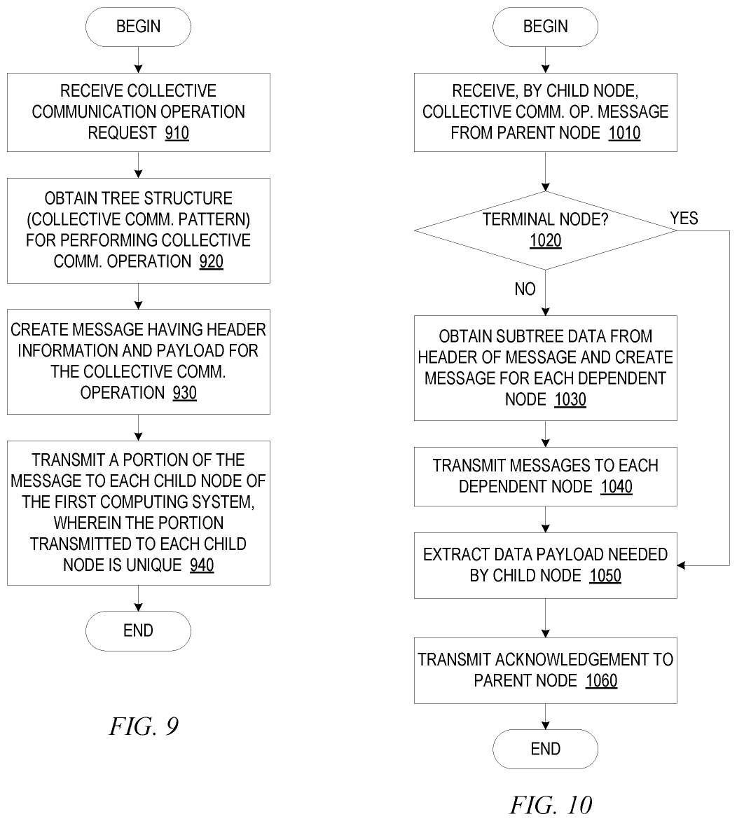

FIG. 9 is a flowchart outlining an example operation for initiating a collective communication operation in accordance with one or more illustrative embodiments. In one or more of the illustrative embodiments outlined in FIG. 9, the collective communication operation is one of a broadcast operation, a scatter operation, or a combination of broadcast and scatter operations. As illustrated, the operation 900 includes receiving a request to perform a collective communication operation (step 910). Next, a tree structure is obtained for performing the collective communication operation (step 920). This tree structure may be a collective communication pattern generated by a CCPA service engine 200 of one or more of the illustrative embodiments as described above.

In some illustrative embodiments, a computing system that is initiating a collective communication operation is a root node of the tree structure. A message, having header information and a payload for the collective communication operation is generated (step 930). In some illustrative embodiments, the message is created by organizing the header information and the payload based on the tree structure. In some illustrative embodiments, the header information and the payload are organized such that a portion of the header information and a portion of the payload data to be transmitted to a child node are contiguous. The operation in FIG. 9 further includes transmitting a portion of the message to each child node of a first computing system, wherein the portion transmitted to each child node is unique (step 940). In some illustrative embodiments, the portion of the message transmitted to each child node includes a child header that defines a sub-tree of the child node. The operation then terminates.

In some illustrative embodiments, the collective communication operation is a broadcast operation and the payload of the message transmitted to each child includes a broadcast payload, which is the same for each child node. In another illustrative embodiment, the distributed communication operation is a scatter operation and the portion of the message transmitted to each child includes a scatter payload obtained based on the payload. The individual scatter payloads transmitted to each child node are different than the scatter payloads transmitted to other child nodes.

Referring now to FIG. 10, a flowchart outlining an example operation for performing a collective communication operation from the view of a child node in accordance with one or more illustrative embodiments is provided. As shown in FIG. 10, the operation starts with a child node receiving a collective communication operation message from a parent node (step 1010). In some illustrative embodiments, the collective communication operation is one of a broadcast operation, a scatter operation, or a combination of broadcast and scatter operations. Once the child node receives the collective communication operation message, it obtains information regarding its subtree from a header of the distributed communication operation message (step 1020). Next, based on the subtree information, a determination is made as to whether the child node a terminal node or not (step 1030).

Based on a determination that the child node is a terminal node, the child node extracts the data payload needed by the child node (step 1040). Based on a determination that the child node is not a terminal node, the child node obtains sub-tree data from a header of the message and creates a message for each node that depends from the child node (step 1050). In some illustrative embodiments, the message created for each node only includes header information and payload data that is required for the sub-tree corresponding to the destination child node. The message transmitted to each child node can include one or more of a broadcast header, a scatter header, a broadcast payload and a scatter payload. The messages are then transmitted to each node that depends from the child node (step 1060) and an acknowledgment message is transmitted back to the parent node (step 1070). The operation then terminates. It should be appreciated that this process may be repeated for each subsequent child node.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for optimization of a collective communication operation, the method comprising:
generating a network graph data structure for a network of computing devices, wherein the network graph data structure comprises nodes representing computing devices of the network and edges comprising communication links between the computing devices;
weighting each edge of the network graph data structure based on a multi-dimensional weight comprising network performance characteristics collected from the network;
determining, for a specified collective communication operation and for participant devices of the network that are participating in the specified collective communication operation, a collective communication pattern based on the multi-dimensional weights of the network graph data structure and a type of the collective communication operation; and
returning the determined collective communication pattern to one or more of the participant devices which perform the collective communication operation based on the collective communication pattern.

2. The method of claim 1, further comprising updating the multi-dimensional weights of the edges of the network graph based on current detected network events.

3. The method of claim 1, further comprising:
generating a token for the collective communication pattern;
providing the token to the one or more participant devices; and
storing the collective communication pattern in a collective communication pattern storage in association with the token for later retrieval when processing a subsequent collective communication operation request from a participant device of the one or more participant devices.

4. The method of claim 3, further comprising:
receiving the subsequent collective communication operation request from the participant device, wherein the subsequent collective communication operation request comprises the token;
retrieving the collective communication pattern from the collective communication pattern storage based on a lookup of the token; and
returning the collective communication pattern to the participant device without having to re-generate the collective communication pattern.

5. The method of claim 1, further comprising:
updating the collective communication pattern associated with the token based on detected network events; and
associating the updated collective communication pattern with the token in response to the updating.

6. The method of claim 1, wherein the network performance characteristics for determining the multidimensional weight for each edge in the network graph comprises at least one of network latency, network bandwidth, network congestion, network usage, network process affinity, or historical network data patterns.

7. The method of claim 1, wherein determining the collective communication pattern and returning the determined collective communication pattern are performed in response to receiving a request from a participant process executing on a computing device, wherein the request specifies the type of collective communication operation to be performed and participant processes of the collective, and wherein the collective communication pattern is determined based on the type of collective communication operation to be performed, wherein different types of collective communication operations result in different collective communication patterns.

8. The method of claim 1, wherein determining the collective communication pattern and returning the determined collective communication pattern are performed in response to receiving a request from a process executed on a computing device, wherein the process is one of a plurality of processes of a parallel application.

9. The method of claim 1, wherein determining the collective communication pattern comprises applying one or more prioritization rules associated with the type of the collective communication operation, wherein different types of collective communication operations are associated with different prioritization rules, and wherein the one or more prioritization rules specify priorities of different ones of the network performance characteristics.

10. The method of claim 1, wherein returning the determined collective communication pattern comprises returning the determined collective communication pattern as a hierarchical tree data structure specifying a pattern of communications between participants of the collective communication operation.

11. A computer program product comprising a computer readable storage medium having a computer readable program stored therein, wherein the computer readable program, when executed on a data processing system, causes the data processing system to:
generate a network graph data structure for a network of computing devices, wherein the network graph data structure comprises nodes representing computing devices of the network and edges comprising communication links between the computing devices;
weight each edge of the network graph data structure based on a multi-dimensional weight comprising network performance characteristics collected from the network;
determine, for a specified collective communication operation and for participant devices of the network that are participating in the specified collective communication operation, a collective communication pattern based on the multi-dimensional weights of the network graph data structure and a type of the collective communication operation; and
return the determined collective communication pattern to one or more of the participant devices which perform the collective communication operation based on the collective communication pattern.

12. The computer program product of claim 11, further comprising updating the multi-dimensional weights of the edges of the network graph based on current detected network events.

13. The computer program product of claim 11, wherein the computer readable program further causes the data processing system to:
generate a token for the collective communication pattern;
provide the token to the one or more participant devices; and
store the collective communication pattern in a collective communication pattern storage in association with the token for later retrieval when processing a subsequent collective communication operation request from a participant device of the one or more participant devices.

14. The computer program product of claim 13, wherein the computer readable program further causes the data processing system to:
receive the subsequent collective communication operation request from the participant device, wherein the subsequent collective communication operation request comprises the token;
retrieve the collective communication pattern from the collective communication pattern storage based on a lookup of the token; and
return the collective communication pattern to the participant device without having to re-generate the collective communication pattern.

15. The computer program product of claim 11, wherein the computer readable program further causes the data processing system to:
update the collective communication pattern associated with the token based on detected network events; and
associate the updated collective communication pattern with the token in response to the updating.

16. The computer program product of claim 11, wherein the network performance characteristics for determining the multidimensional weight for each edge in the network graph comprises at least one of network latency, network bandwidth, network congestion, network usage, network process affinity, or historical network data patterns.

17. The computer program product of claim 11, wherein determining the collective communication pattern and returning the determined collective communication pattern are performed in response to receiving a request from a participant process executing on a computing device, wherein the request specifies the type of collective communication operation to be performed and participant processes of the collective, and wherein the collective communication pattern is determined based on the type of collective communication operation to be performed, wherein different types of collective communication operations result in different collective communication patterns.

18. The computer program product of claim 11, wherein determining the collective communication pattern and returning the determined collective communication pattern are performed in response to receiving a request from a process executed on a computing device, wherein the process is one of a plurality of processes of a parallel application.

19. The computer program product of claim 11, wherein determining the collective communication pattern comprises applying one or more prioritization rules associated with the type of the collective communication operation, wherein different types of collective communication operations are associated with different prioritization rules, and wherein the one or more prioritization rules specify priorities of different ones of the network performance characteristics.

20. An apparatus comprising:
at least one processor; and
at least one memory coupled to the at least one processor, wherein the at least one memory comprises instructions which, when executed by the at least one processor, cause the at least one processor to:
generate a network graph data structure for a network of computing devices, wherein the network graph data structure comprises nodes representing computing devices of the network and edges comprising communication links between the computing devices;
weight each edge of the network graph data structure based on a multi-dimensional weight comprising network performance characteristics collected from the network;
determine, for a specified collective communication operation and for participant devices of the network that are participating in the specified collective communication operation, a collective communication pattern based on the multi-dimensional weights of the network graph data structure and a type of the collective communication operation; and
return the determined collective communication pattern to one or more of the participant devices which perform the collective communication operation based on the collective communication pattern.
